(19) United States
(12) Patent Application Publication
(10) Pub. No.: US 2011/0064841 A1
(43) Pub. Date: Mar. 17, 2011

(54) Molding Apparatus for Modified Sulfur Concrete Substance Product

(75) Inventors: Minoru Kurakake, Tokyo (JP); Hideyuki Horii, Tokyo (JP); Yoshifumi Tominaga, Takeo (JP); Yasunori Yamaguchi, Takeo (JP)

(73) Assignees: NIPPON OIL CORPORATION, Tokyo (JP); FUJI CONCRETE INDUSTRY CO., LTD., Takeo (JP)

(21) Appl. No.: 12/948,537

(22) Filed: Nov. 17, 2010

Related U.S. Application Data
(63) Continuation of application No. PCT/JP2009/055785, filed on Mar. 24, 2009.

(30) Foreign Application Priority Data
Sep. 12, 2008 (JP) 2008-234316

(51) Int. Cl. B28B 1/24

(52) U.S. Cl. 425/548

(57) ABSTRACT

In the present invention, as a sulfur-containing material fully filled into a cavity of a mold body in which the inside of an outer mold having the cavity which can be hermetically sealed is heated to a temperature within a preset temperature range of which a lower limit is equal to or above a melting point of sulfur is cooled and contracted in the cavity, the sulfur-containing material stored in a filling tank in which a cover is attached to an upper end opening of filling tank, so that the inside of filling tank can be hermetically sealed, and also, the inside of filling tank is pressurized to a predetermined pressure, and the inside of filling tank is heated to a temperature within the preset temperature range, is replenished into the cavity by a pressure in filling tank to mold a modified sulfur concrete substance product.

### CROSS-REFERENCE TO RELATED APPLICATIONS

This application is a continuation of international Patent Application PCT/JP2009/55785, filed on Mar. 24, 2009, which claims priority to foreign Patent Application JP 2008234316, filed on Sep. 12, 2008, the disclosures of which are incorporated herein by reference in their entirety.

### FIELD OF THE INVENTION

The present invention relates to a molding apparatus for modified sulfur concrete substance product, which fills a sulfur-containing material in a melted state into a cavity of a mold body and then cools and solidifies the sulfur-containing material to mold the modified sulfur concrete substance product. More specifically, the present invention relates to a molding apparatus for modified sulfur concrete substance product which, as a sulfur-containing material filled into a cavity is cooled and contracted, replenishes the sulfur-containing material in a filling tank in a pressurized state into the cavity.

### BACKGROUND OF THE INVENTION

Generally, concrete obtained by combining aggregates by cement is used as civil-engineering material and constructing material. The sulfur recently receives an attention due to the characteristic that sulfur is a solid at room temperature while melted upon being heated to about 119 to 159° C., and it is attempted that the sulfur is utilized as a civil-engineering material and a construction material by mixing a predetermined sample or predetermined samples in it. It is known that the sulfur-containing material using the sulfur has high strength, an excellent water-sealing property and high acid resistance, as compared with the usual concrete using cement. Further, since the sulfur-containing material is apparently similar to a usual concrete in finishing and handling, sometimes the solidified sulfur-containing material is called sulfur concrete substance.

Since, sulfur has ignition property and is dealt with a hazardous material. It is difficult to perform construction by melting, casting and solidifying the sulfur material on site. Therefore, in order to improve such a situation, it is attempted that the sulfur is denatured to produce modified sulfur by mixing a sulfur modifying agent as an additive into molten sulfur. Further, it is attempted that a modified sulfur intermediate material in a melt state is produced by mixing the modified sulfur and fine powders, and a modified sulfur concrete substance is produced by mixing the modified sulfur intermediate material with the aggregate and solidifying the mixture.

Further, in order to form the sulfur concrete substance or the modified sulfur concrete substance by making the sulfur-containing material (or the modified sulfur intermediate material) in a melted state cooled and solidified, the sulfur-containing material is filled into a mold having a predetermined shape and is then cooled and solidified.

There is not a dedicated mold for filling, cooling, and solidifying the sulfur-containing material. As a mold for molding a usual concrete product, there is a mold for filling concrete into a cavity formed between an outer mold and an inner mold to produce a cylindrical concrete product and the like.

However, a means for heating the outer mold and the inner mold is not provided in the molds described. The sulfur-containing material in a melted state starts to solidify at the time point when the temperature is below solidification temperature (about 119° C.) of the sulfur and solidified to have high strength which is equal to or higher than that of usual concrete. Conventionally, when the sulfur-containing material in a melted state solidifies, a part which is in contact with the mold when the material is poured into the mold is cooled rapidly, so that a problem occurs such that the surface of the sulfur concrete substance or the modified sulfur concrete substance removed from the mold is rough.

Further, the sulfur-containing material in a melted state filled into the mold is contracted in the process of cooling and solidification. Thus, even when the sulfur-containing material is fully filled to the upper surface portion of the mold, it is sunk, thereby causing a gap in the upper portion of the product, so that a specification requirement of the product may not be satisfied. In this case, up to now, the sulfur-containing material is coated onto the product taken out by dividing the mold into two parts for repair, however, this requires excessive time and labor, and also, finishing is poor to deteriorate the value of the product. Furthermore, when the gap is large, the product may not be repaired.

Still further, the sulfur-containing material is injected into the mold without covering a filling port of the mold and the upper surface of the sulfur-containing material filled into the mold is sunk to cause a gap, and thereafter, the sulfur-containing material is replenished. During that, the surface of the sulfur-containing material starts to solidify to generate a hardened layer, so that the strength of the product is weakened. In this case, a performance requirement of the product may not be satisfied.

### SUMMARY OF THE INVENTION

In view of the above described problems, a molding apparatus for modified sulfur concrete substance product is provided which, as a sulfur-containing material filled into a cavity is cooled and contracted, replenishes the sulfur-containing material in a filling tank in a pressurized state into the cavity.

A molding apparatus for modified sulfur concrete substance product according to an embodiment of the present invention includes: a mold body in which an outer mold thereof having a cavity which stores therein a sulfur-containing material being heated to a temperature within a preset temperature range of which a lower limit is equal to or above a melting point of sulfur to be in a melted state and can be hermetically sealed, is provided in a portion thereof with a filling port for the sulfur-containing material communicating with the cavity, the inside of the outer mold being heated to a temperature within the preset temperature range; and a filling tank in which a lower end injecting port thereof is detachably attached to the filling port of the mold body, the sulfur-containing material supplied from an injecting hopper storing the sulfur-containing material therein is received from an upper end opening of the filling tank to supply the sulfur-containing material into the cavity through the filling port of the mold body, a cover is attached to the upper end opening of the filling tank in the state that a predetermined amount of the sulfur-containing material is stored in the filling tank, so that the inside of the filling tank can be hermetically sealed, and also, the inside of the filling tank is pressurized to a predetermined pressure and the inside of the filling tank is heated to a temperature within the preset temperature range, wherein as the sulfur-containing material fully filled into the cavity of the mold body is cooled and contracted in the cavity, the sulfur-containing material stored in the filling tank is replenished into the cavity by a pressure in the filling tank.

With such configuration, as the sulfur-containing material fully filled into the cavity of the mold body in which the inside of the outer mold having the cavity which can be hermetically sealed is heated to a temperature within the preset temperature range of which a lower limit is equal to or above a melting point of sulfur, is cooled and contracted in the cavity, the sulfur-containing material stored in the filling tank in which the cover is attached to the upper end opening thereof, so that the inside of the filling tank can be hermetically sealed, and the inside of the filling tank is pressurized to a predetermined pressure, and also, the inside of the filling tank is heated to a temperature within the preset temperature range, is replenished into the cavity by the pressure in the filling tank. Namely, as the sulfur-containing material is cooled and contracted in the cavity of the mold body, the sulfur-containing material in the contracted amount can be automatically replenished from the filling tank. Accordingly, this does not require excessive time and labor. Further, the strength of the modified sulfur concrete substance product is increased, and also, finishing becomes good to enhance the value of the product.

The volume of the filling tank is equal to or larger than the volume of the sulfur-containing material fully filled into the cavity of the mold body, which is cooled and contracted. Therefore, the sulfur-containing material is replenished from the filling tank by the volume of the sulfur-containing material fully filled into the cavity of the mold body, which is cooled and contracted. Consequently, the sulfur-containing material can be automatically replenished from the filling tank by the amount of the sulfur-containing material contracted in the cavity of the mold body.

Still further, in order to heat the mold body and the filling tank to a temperature within the preset temperature range of which a lower limit is equal to or above a melting point of sulfur, heating means is attached to each of the mold body and the filling tank. The heating means attached to each of the components themselves heats the mold body and the filling tank to a temperature within the preset temperature range of which a lower limit is equal to or above a melting point of sulfur. Thus, the temperature of the mold body and the filling tank can be maintained at a temperature equal to or above a melting point of the sulfur, and the sulfur-containing material in a melted state can be filled from the filling tank into the cavity of the mold body.

Still further, one or a plurality of the filling ports of the mold body are provided in a part of the outer mold, and one or a plurality of the filling tanks are attached to the mold body. One or a plurality of the filling tanks are attached according to the volume of the mold body. Accordingly, the present invention can respond to the mold bodies having various volumes, in addition, the mold bodies positioned in tilted, vertical, and horizontal states.

### BRIEF DESCRIPTION OF THE DRAWINGS

FIG. 1 is a schematic view illustrating an embodiment of a molding apparatus for modified sulfur concrete substance product according to an embodiment of the present invention;

FIG. 2 is a front view illustrating a filling tank of the molding apparatus;

FIG. 3 is a perspective view illustrating a mold body of the molding apparatus;

FIG. 4 is a perspective view illustrating the state before the filling tank is attached to the mold body;

FIG. 5 is a perspective view illustrating the state after the filling tank is attached to the mold body;

FIG. 6 is a perspective view illustrating the state that a cover and pressurizing means are attached to the filling tank;

FIGS. 7A and 7B are perspective views illustrating the state that a sulfur-containing material is automatically replenished from the filling tank into the mold body, in which FIG. 7A is a view illustrating a state before filling and FIG. 7B is a view illustrating a state after filling;

FIG. 8 is a perspective view illustrating another embodiment of the molding apparatus of the present invention; and

FIG. 9 is a perspective view illustrating a further embodiment of the molding apparatus of the present invention.

### DETAILED DESCRIPTION

Preferred embodiments of the present invention will be described below in detail with reference to the accompanying drawings.

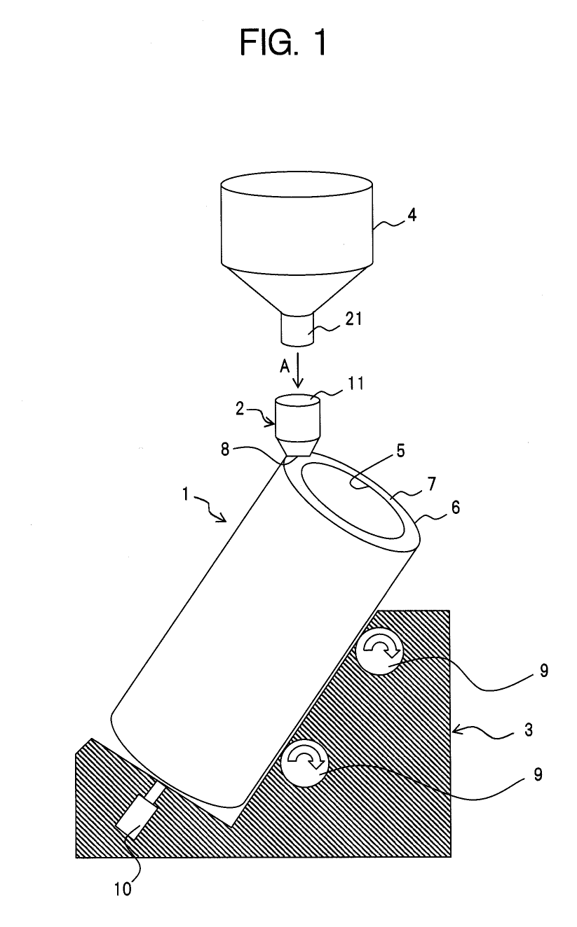

FIG. 1 is a schematic view illustrating an embodiment of a molding apparatus for modified sulfur concrete substance product according to the present invention.

The molding apparatus for modified sulfur concrete substance product fills a sulfur-containing material in a melted state into a cavity of a mold body and then cools and solidifies the sulfur-containing material to mold the modified sulfur concrete substance product. As illustrated in FIG. 1, the molding apparatus for modified sulfur concrete substance product has a mold body 1 and a filling tank 2. In FIG. 1, the reference numeral 3 denotes a vibrating table supporting mold body 1 positioned in a tilted state, and the reference numeral 4 denotes an injecting hopper supplying the sulfur-containing material into filling tank 2.

Mold body 1 fills the sulfur-containing material in a melted state therein and then cools and solidifies the sulfur-containing material. Mold body 1 is made of metal such as steel or aluminum, and is formed in a shape adapted to the shape of the modified sulfur concrete substance product to be produced. For example, mold body 1 illustrated in FIG. 1 is used to produce a cylindrical modified sulfur concrete substance product, such as a fume pipe or a manhole, and has a cylindrical inner mold 5, a cylindrical outer mold 6 and an end planks 7 arranged at both ends thereof.

Inner mold 5 specifies the inner peripheral surface of the cylindrical product to be produced and is made by a member whose outer peripheral surface is formed in a columnar shape with a predetermined length. Outer mold 6 specifies the outer peripheral surface of the cylindrical product to be produced and is made by a member which has an inside diameter larger than the outside diameter of inner mold 5, and is formed in a cylindrical shape with a predetermined length. End planks 7 specify both end faces of the cylindrical product to be produced, and is formed in a donut plate shape or in a circular plate shape having an outside diameter equal to or larger than the outside diameter of outer mold 6, and is arranged at both ends of inner mold 5 and outer mold 6.

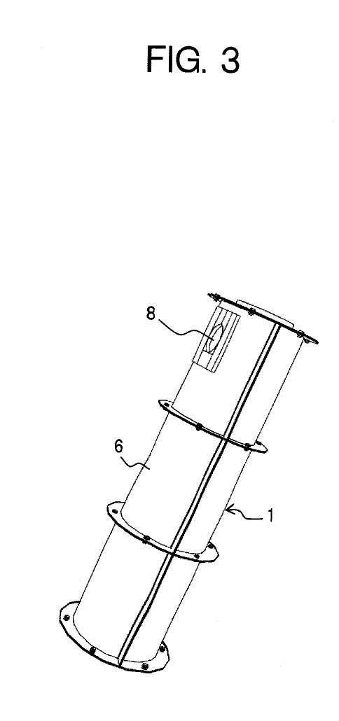

In this state, in a space surrounded by inner mold 5, outer mold 6, and end planks 7, the cavity which stores therein the sulfur-containing material being heated to a temperature within a preset temperature range of which a lower limit is equal to or above the melting point (119° C.) of sulfur (for example, about from 120 to 150° C.) to be in a melted state and can be hermetically sealed, is formed. As illustrated in FIG. 3, a filling port 8 of the sulfur-containing material communicating with the cavity is provided in a portion, e.g., the upper end, of outer mold 6. Although not illustrated in the figure, an air vent hole communicating with the cavity is formed in a portion, e.g., the upper end, of outer mold 6.

The outer peripheral portion of outer mold 6 is provided with heating means such as an electric heater, a hot-air heater, or an oil heater and is covered with a heat insulating material. The inside of outer mold 6 is heated to a temperature within the preset temperature range of which a lower limit is equal to or above a melting point of sulfur (for example, about from 120 to 150° C.). Accordingly, in the range, the sulfur-containing material injected into outer mold 6 is maintained in a melted state without solidifying, and is spread to the entire cavity surrounded by inner mold 5, outer mold 6, and end planks 7

As illustrated in FIG. 1, the above-mentioned mold body 1 is placed on vibrating table 3 and is supported in a tilted state. Vibrating table 3 has a vibrator 9 and a knocker 10, and is configured to vibrate the whole of mold body 1. Cylindrical mold body 1 may be divided into two parts so as to be in a semi-cylindrical shape along its longitudinal direction.

Mold body 1 illustrated in FIGS. 1 and 3 indicates a mold shape in the case of molding the cylindrical product by modified sulfur concrete substance. In the case of manufacturing a product having a shape other than the cylindrical shape, the shape of inner mold 5, outer mold 6, and end planks 7 may be determined adapted to the shape of the product. When the shape of the product is not a pipe shape and is a plate shape, a board shape, or a block shape, inner mold 5 may be unnecessary.

The sulfur-containing material will be explained below. The sulfur-containing material is called a sulfur concrete substance produced by, using the characteristics that the sulfur is solid at room temperature while melted upon being heated to about 119 to 159° C., mixing sands, gravels, coal ashes or the like with the sulfur melted by being heated to a temperature within the preset temperature range of which a lower limit is equal to or above 119° C. and kneading the mixed material while maintaining the temperature at about 119 to 159° C., and thereafter, cooling and hardening the kneaded material. The sulfur-containing material may be called a modified sulfur concrete substance produced by mixing the sulfur melted by being similarly heated to a temperature within the preset temperature range of which a lower limit is equal to or above 119° C. with a sulfur modifying agent which denatures the melted sulfur to produce modified sulfur, and mixing sands, gravels, coal ashes or the like with the modified sulfur, and kneading the mixed material by being heated in a manner similar to the above, and thereafter, cooling and hardening the knead material. That is, the sulfur-containing material includes the sulfur concrete substance and the modified sulfur concrete substance. As used herein, the term “modified sulfur concrete substance” intends to include, but not limited to, “sulfur concrete substance”.

The modified sulfur concrete substance will be further described in detail. The modified sulfur concrete substance is produced by using sulfur, a sulfur modifying agent, fine powders, and aggregate as materials. First, the melted sulfur and the sulfur modifying agent are mixed to produce the modified sulfur. Sulfur is usual simple sulfur and is, for example, natural sulfur or sulfur produced by desulfurizing petroleum or natural gas. The sulfur modifier performs modification by denaturing the melted sulfur, for example, polymerizing sulfur. The sulfur modifying agent may be any compound which can polymerize sulfur. For example, the sulfur modifier is olefinic hydrocarbon or diolefin hydrocarbon having carbon number of from 4 to 20, concretely, the sulfur modifier is one of a cyclic olefinic hydrocarbon such as limonene or pinene, aromatic hydrocarbon such as styrene, vinyl toluene, or methylstyrene, and diene hydrocarbon such as dicyclopentadiene (DCPD) and its oligomer, cyclopentadiene, tetrahydroindene (THI), vinylcyclohexene, vinylnorbornene, ethylidene norbornene, or cyclooctadiene, or a mixture of two or more of the hydrocarbons. The sulfur and the sulfur modifying agent are mixed in a state where sulfur is melted, that is, at a temperature range from 119 to 159° C., preferably, from 135 to 150° C.

The modified sulfur can be obtained by melt-mixing the sulfur with sulfur modifying agent. The percent of use of the sulfur modifying agent in this case is, preferably, from 0.1 to 30 percent by mass, more preferably, from 1.0 to 20 percent by mass to the total amount of sulfur and the sulfur modifying agent. The obtained modified sulfur is mixed with fine powders heated to a predetermined temperature (for example, 150° C.), thereby obtaining a modified sulfur intermediate material. As the fine powders, one or more of coal ash, siliceous, silica fume, glass powders, fuel incineration, electrically collected dust and crushed sea shell may be selected.

The obtained modified sulfur intermediate material is mixed with the aggregate heated to, for example, about from 130 to 140° C. in a state where the temperature is maintained at a temperature at which a melt state can be maintained (for example, from 130 to 140° C.). The aggregate is not limited as long as it can be used as aggregate, and aggregate generally used for concrete can be used. Examples of such aggregate are one or more materials selected from the group of natural stones, sands, gravels, siliceous, iron and steel slag, ferronickel slag, copper slag, side product generated at the time of manufacturing a metal, liquid slags, shells and a mixture of the materials. By mixing the modified sulfur intermediate material and the aggregate by using, for example, a kneading unit, the modified sulfur material is produced, and thereafter, by cooling and solidifying the modified sulfur material, a modified sulfur concrete substance is produced. Such a modified sulfur concrete substance can be produced by using, for example, a modified sulfur concrete substance producing system disclosed in Japanese Patent Publication No. 4,007,997.

In the following description, such a sulfur concrete substance or a modified sulfur concrete substance is heated in the preset temperature range, and the resultant is used as a sulfur-containing material in a melt state.

Filling tank 2 is detachably attached to filling port 8 of mold body 1. As illustrated in FIG. 1, filling tank 2 receives the sulfur-containing material supplied from injecting hopper 4 storing the sulfur containing material therein, as indicated by an arrow A, from an upper end opening 11 thereof to supply the sulfur containing material into the cavity through filling port 8 of mold body 1 (refer to FIG. 3).

Injecting hopper 4 is made of a metal and formed in a funnel shape, and a volume of injecting hopper 4 is, for example, about 1.0 m³. The peripheral portion of injecting hopper 4 is provided with heating means such as an electric heater, a hot-air heater, or an oil heater and is covered with a heat insulating material. Injecting hopper 4 is heated to a temperature within the preset temperature range of which a lower limit is equal to or above the melting point of sulfur. The preset temperature range of the heating is preferably about from 120 to 150° C. In the range, the sulfur containing material in a melted state stored in injecting hopper 4 is maintained in a melted state without solidifying.

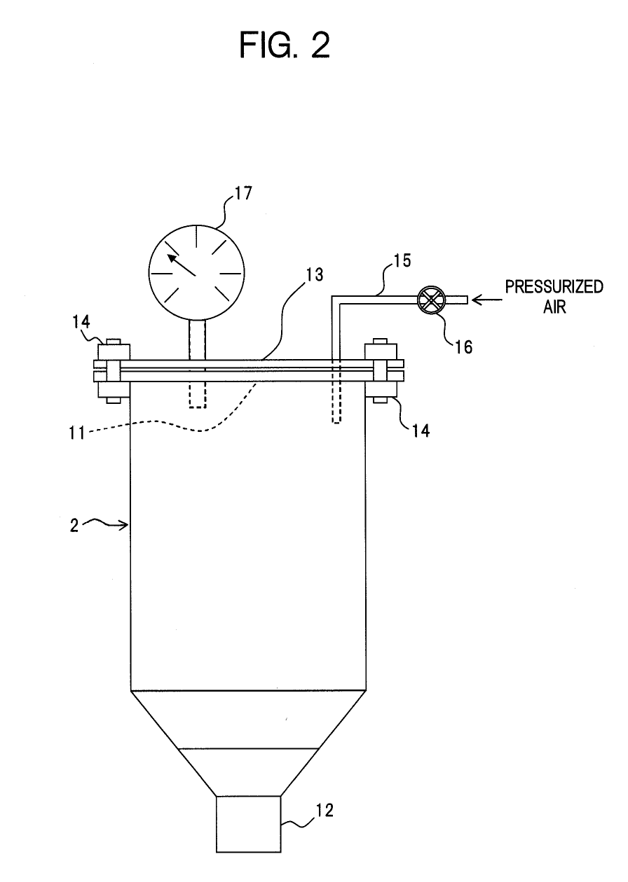

As illustrated in FIG. 2, the whole of filling tank 2 is made of a metal and formed in a funnel shape. A lower end indicating port 12 of filling tank 2 is detachably attached to filling port 8 of mold body 1. A cover 13 is attached to upper end opening 11 of filling tank 2 by fasteners 14 such as bolts in the state that a predetermined amount of the sulfur-containing material supplied from injecting hopper 4 illustrated in FIG. 1 is stored in filling tank 2, so that the inside of filling tank 2 can be hermetically sealed.

The volume of filling tank 2 is equal to or larger than the volume of the sulfur-containing material which is fully filled into the cavity of mold body 1 to be cooled and contracted. The contraction rate of the cooled and solidified sulfur-containing material is said to be 7 to 8% calculated in terms of volume. Therefore, the volume of filling tank 2 is 7 to 8% or above of the volume of the modified sulfur concrete substance product molded in the cavity of mold body 1.

Cover 13 of filling tank 2 is connected to a pressurized air supply pipe 15. The front end of supply pipe 15 is inserted into filling tank 2. Thus, the inside of filling tank 2 is pressurized to a predetermined pressure (for example, from 0.05 to 0.15 MPa). Although not illustrated in the figure, the base end portion of supply pipe 15 is connected to such as an air pump as pressurizing means. The supply of the pressurized air is controlled by an open and close valve 16. In FIG. 2, the reference numeral 17 denotes a pressure meter (which is attached to cover 13) measuring a pressure in filling tank 2.

The peripheral portion of filling tank 2 is provided with heating means such as an electric heater, a hot-air heater, or an oil heater and is covered with a heat insulating material. The inside of filling tank 2 is heated to a temperature within the preset temperature range of which a lower limit is equal to or above the melting point of sulfur. The preset temperature range of the heating is preferably about from 120 to 150° C. In the range, the sulfur-containing material in a melted state stored in filling tank 2 is maintained in a melted state without solidifying.

Filling tank 2 is attached to filling port 8 of mold body 1. The sulfur-containing material in a melted state is supplied from injecting hopper 4 to filling tank 2. The sulfur-containing material is supplied into the cavity of mold body 1. As the sulfur-containing material fully filled into the cavity of mold body 1 is cooled and contracted in the cavity, the sulfur-containing material stored in filling tank 2 is replenished into the cavity by a pressure in filling tank 2.

Next, with reference to FIGS. 3 to 7, a use state of the molding apparatus for modified sulfur concrete substance product will be described.

In FIG. 1, mold body 1 is placed on vibrating table 3 and is supported in a tilted state. In this state, filling tank 2 is attached to filling port 8 provided at the upper end of outer mold 6 of mold body 1 illustrated in FIG. 3.

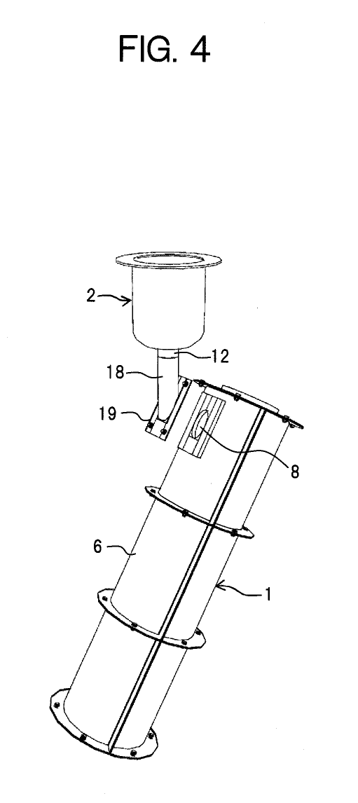

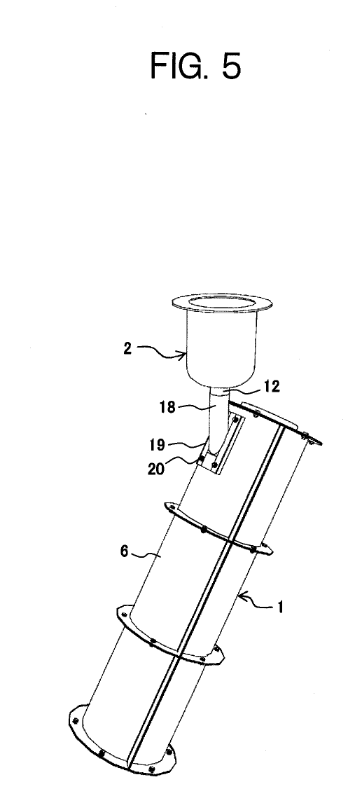

As illustrated in FIG. 4, an attaching plate 19 provided in a tilted state at the lower end of an attaching pipe 18 connected to lower end injecting port 12 of filling tank 2 is aligned to filling port 8 of mold body 1 to communicate lower end injecting port 12 of filling tank 2 with filling port 8 of mold body 1. As illustrated in FIG. 5, four corners of attaching plate 19 are secured by fasteners 20 such as bolts to attach filling tank 2 to filling port 8 of outer mold 6 of mold body 1. Attaching plate 19 of filling tank 2 is secured by fasteners 20 such as bolts, and therefore, filling tank 2 is detachably attached to filling port 8 of mold body 1. In this state, cover 13 illustrated in FIG. 2 is not attached to filling tank 2.

In such state, as illustrated in FIG. 1, injecting hopper 4 is aligned above filling tank 2 to supply the sulfur-containing material from an injecting port 21 of injecting hopper 4 to upper end opening 11 of filling tank 2, as indicated by the arrow A. Filling tank 2 receives the sulfur-containing material from upper end opening 11 thereof to subsequently supply the sulfur-containing material into the cavity through filling port 8 (refer to FIG. 3) of mold body 1.

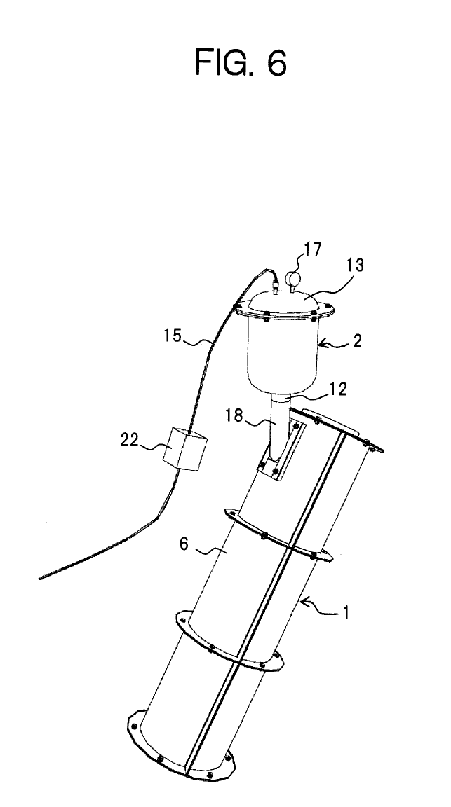

As described above, when the sulfur-containing material is fully filled into the cavity of mold body 1 and also when a predetermined amount of the sulfur-containing material is stored in filling tank 2, the injection of the sulfur-containing material from injecting hopper 4 is stopped. As illustrated in FIG. 6, cover 13 is attached to upper end opening 11 of filling tank 2 illustrated in FIG. 1 to thereby hermetically seal the inside of filling tank 2. Further, cover 13 is connected to pressurized air supply pipe 15 and the front end thereof is inserted into filling tank 2. To the base end of supply pipe 15, the air pump, not illustrated, is connected to supply pressurized air via a pressure adjuster 22. At this point, the inside of filling tank 2 is constantly pressurized to about 0.05 to 0.15 MPa.

In this state, in FIG. 6, the operation of the heating means of mold body 1 is stopped to stop heating the sulfur-containing material filled into mold body 1, and mold body 1 is left as it is. As mold body 1 is gradually cooled in an atmosphere at room temperature, the sulfur-containing material fully filled into the cavity of mold body 1 is cooled, contracted, and sunk in the cavity. As the sulfur-containing material in mold body 1 is contracted, the sulfur-containing material stored in filling tank 2 is replenished into the cavity of mold body 1 by a pressure in filling tank 2.

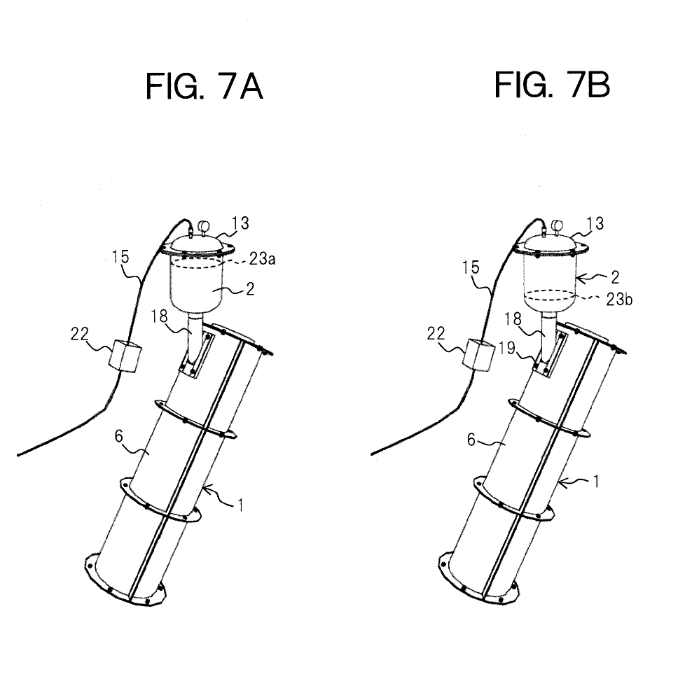

As illustrated in FIG. 7A, immediately after the sulfur-containing material is fully filled into the cavity of mold body 1, the sulfur-containing material is stored in filling tank 2 to a material position indicated by the reference numeral 23a. As described above, the operation of the heating means of mold body 1 is stopped, and mold body 1 is left to cool. After an elapse of an appropriate time, as illustrated in FIG. 7B, the sulfur-containing material in filling tank 2 is sunk to a material position indicated by the reference numeral 23b. In this case, as the sulfur-containing material in mold body 1 is contracted and sunk, the sulfur-containing material of which volume in filling tank 2 lowered from material position 23a to material position 23b is automatically replenished into the cavity of mold body 1. Time to leave and cool mold body 1 (refer to FIG. 7A) and to fill a predetermined amount of the sulfur-containing material from filling tank 2 into mold body 1 (refer to FIG. 7B) is about from two hours to two and a half hours.

After that, in FIG. 7B, attaching plate 19 at the lower end of attaching pipe 18 of filling tank 2 is detached to remove filling tank 2 from mold body 1, and then, mold body 1 is divided into two parts so as to be in a semi-cylindrical shape along its longitudinal direction to take out the modified sulfur concrete substance product which is cooled and solidified therein. In this state, as the sulfur-containing material is cooled and contracted in the cavity of mold body 1, the sulfur-containing material in the contracted amount thereof is automatically replenished from filling tank 2 and is solidified to mold the clean modified sulfur concrete substance product without a gap.

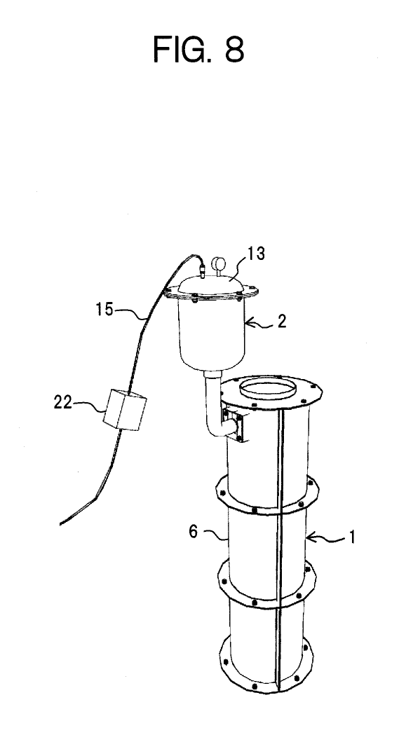

FIG. 8 is a perspective view illustrating another embodiment of the molding apparatus of the present invention.

In this embodiment, mold body 1 is supported in a vertical state on a table or a supporting base which is not illustrated, and also, filling tank 2 is detachably attached to the upper end of outer mold 6 of mold body 1. Except for this, this embodiment is the same as the embodiment illustrated in FIG. 1.

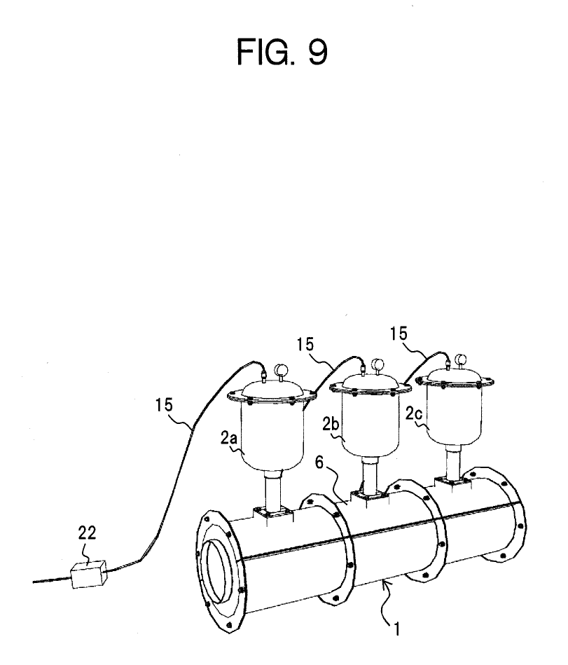

FIG. 9 is a perspective view illustrating a further embodiment of the molding apparatus of the present invention.

In this embodiment, mold body 1 is supported in a horizontal state on a table or a supporting base which is not illustrated, and also, a plurality of, e.g., three filling tanks 2a, 2b, and 2c, are detachably attached to the upper surface of outer mold 6 of mold body 1. The number of filling tanks 2 may be appropriately changed according to the volume of mold body 1. Except for this, this embodiment is the same as the embodiment illustrated in FIG. 1.

It should also be understood that many modifications and variations of the described embodiments of the invention will occur to a person having an ordinary skill in the art without departing from the spirit and scope of the present invention as claimed in the appended claims.

What is claimed is:

1. A molding apparatus for modified sulfur concrete substance product, comprising:
a mold body in which an outer mold thereof having a cavity which stores therein a sulfur-containing material being heated to a temperature within a preset temperature range of which a lower limit is equal to or above a melting point of sulfur to be in a melted state and can be hermetically sealed, is provided in a portion thereof with a filling port for the sulfur-containing material communicating with the cavity, the inside of the outer mold being heated to a temperature within the preset temperature range; and
a filling tank in which a lower end injecting port thereof is detachably attached to the filling port of the mold body, the sulfur-containing material supplied from an injecting hopper storing the sulfur-containing material therein is received from an upper end opening of the filling tank to supply the sulfur-containing material into the cavity through the filling port of the mold body, a cover is attached to the upper end opening in the state that a predetermined amount of the sulfur-containing material is stored in the filling tank to hermetically seal the inside of the filling tank, and the inside of the filling tank is pressurized to a predetermined pressure and the inside of the filling tank is heated to a temperature within the preset temperature range,
wherein as the sulfur-containing material fully filled into the cavity of the mold body is cooled and contracted in the cavity, the sulfur-containing material stored in the filling tank is replenished into the cavity by a pressure in the filling tank.

2. The molding apparatus for modified sulfur concrete substance product according to claim 1, wherein the volume of the filling tank is equal to or larger than the volume of the sulfur-containing material fully filled into the cavity of the mold body, which is cooled and contracted.

3. The molding apparatus for modified sulfur concrete substance product according to claim 1, wherein a heating means is attached to each of the mold body and the filling tank to heat the mold body and the filling tank to a temperature within the preset temperature range of which a lower limit is equal to or above a melting point of sulfur.

4. The molding apparatus for modified sulfur concrete substance product according to claim 1, wherein at least one filling port of the mold body is provided in a portion of the outer mold, and at least one filling tank is attached to the mold body.
